(19) United States
(12) Patent Application Publication
(10) Pub. No.: US 2026/0140319 A1
(43) Pub. Date: May 21, 2026

(54) III-NITRIDE-BASED FERROELECTRIC PHOTONIC DEVICES WITH HYBRID RESONATOR CORE

(71) Applicant: The Regents of the University of Michigan, Ann Arbor, MI (US)

(72) Inventors: Jiangnan Liu, Ann Arbor, MI (US); Shuai Liu, Ann Arbor, MI (US); Zheshen Zhang, Ann Arbor, MI (US); Zetian Mi, Ann Arbor, MI (US)

(21) Appl. No.: 19/391,399

(22) Filed: Nov. 17, 2025

Related U.S. Application Data
(60) Provisional application No. 63/721,112, filed on Nov. 15, 2024.

(51) Int. Cl. G02B 6/293; G02B 6/12; G02B 6/13

(52) U.S. Cl. CPC G02B 6/29338; G02B 6/12007; G02B 6/131

(57) ABSTRACT

A photonic device includes a substrate and a waveguide supported by the substrate. The waveguide has a core. The core of the waveguide includes a III-nitride-based layer and a guiding layer adjacent the III-nitride-based layer. The III-nitride-based layer is ferroelectric. The guiding layer has a layout that establishes a lateral extent of the core.

### CROSS-REFERENCE TO RELATED APPLICATION

This application claims the benefit of U.S. provisional application entitled “III-Nitride-Based Ferroelectric Photonic Devices with Hybrid Resonator Core,” filed Nov. 15, 2024, and assigned Ser. No. 63/721,112, the entire disclosure of which is hereby expressly incorporated by reference.

### BACKGROUND OF THE DISCLOSURE

### Field of the Disclosure

The disclosure relates generally to photonic devices.

### Brief Description of Related Technology

Silicon photonics have been extensively studied owing to the great success and mature fabrication processing of silicon microelectronics. Silicon has a large index contrast with a silicon dioxide oxide cladding, making small dimensions possible in photonic integrated circuit components. However, silicon only has a limited transparency window of 1.1 to 4 μm due to its relatively small indirect bandgap, which limits the utility of silicon as an efficient light source. The centrosymmetric crystalline structure of silicon also suppresses second-order nonlinearity.

Another important platform in silicon photonics, Si₃N₄, exhibits a wider bandgap. Efforts have been made to develop low-loss materials based on Si₃N₄ to achieve efficient nonlinear performance. One of the challenges persisting for the Si₃N₄ platform is that the platform lacks second order nonlinearity due to the centrosymmetric structure of Si₃N₄.

Lithium niobate (LiNbO₃) has gained more attention in recent years due to its large optical χ⁽²⁾ nonlinearity. But LiNbO₃ has been challenging in micro-processing, such as dry etching, thickness control, and integration.

Although significant progress has been made in SiNₓ and LiNbO₃ based photonic devices, these platforms have prohibitively high loss in the UV and blue spectrum and do not directly support optoelectronic and electronic functionalities.

Aluminum nitride is an ultrawide bandgap semiconductor (about 6.1 eV), which is transparent from deep ultraviolet (UV) to infrared wavelengths, providing a potentially ultralow-loss optical platform. Several applications, such as high-Q microring resonators, frequency combs, and electro-optical modulators, have been demonstrated on an AlN platform with great performance. However, while the wurtzite noncentrosymmetric structure of AlN provides the devices with second-order optical nonlinearity, its performance parameters are lower than other nonlinear materials such as LiNbO₃.

### SUMMARY OF THE DISCLOSURE

In accordance with one aspect of the disclosure, a photonic device includes a substrate and a waveguide supported by the substrate. The waveguide has a core. The core of the waveguide includes a III-nitride-based layer and a guiding layer adjacent the III-nitride-based layer. The III-nitride-based layer is ferroelectric. The guiding layer has a layout that establishes a lateral extent of the core.

In accordance with another aspect of the disclosure, a photonic device includes a substrate and a heterostructure supported by the substrate. The heterostructure includes a waveguide. The waveguide includes a composite core. The composite core includes a III-nitride-based layer and a guiding layer adjacent the III-nitride-based layer. The III-nitride-based layer is ferroelectric. The guiding layer has a layout that establishes a width of the composite core.

In accordance with yet another aspect of the disclosure, a microring resonator device includes a substrate, a bus waveguide supported by the substrate, and a ring waveguide supported by the substrate and spaced from the bus waveguide. The ring waveguide has a core. The core of the waveguide includes a III-nitride-based layer and a guiding layer adjacent the III-nitride-based layer. The III-nitride-based layer is ferroelectric. The guiding layer has a layout that establishes a lateral extent of the core.

In accordance with still another aspect of the disclosure, a method of fabricating a photonic device includes providing a substrate, growing a III-nitride-based layer of a waveguide core of the photonic device, the III-nitride-based layer being supported by the substrate and ferroelectric, forming a guiding layer of the waveguide core, the guiding layer being supported by the substrate and adjacent the III-nitride-based layer, patterning the guiding layer such that the guiding layer has a layout that establishes a lateral extent of the waveguide core, and forming a cladding layer adjacent the waveguide core.

In connection with any one of the aforementioned aspects, the devices and/or methods described herein may alternatively or additionally include or involve any combination of one or more of the following aspects or features. The guiding layer is supported by the III-nitride-based layer. The III-nitride-based layer is supported by the guiding layer. The photonic device further includes a signal electrode configured to apply an electric field to the core of the waveguide, the signal electrode being supported by, and in contact with, the III-nitride-based layer. The guiding layer includes silicon nitride. The III-nitride-based layer has a layout that establishes the lateral extent of the core. The photonic device further includes an electrode spaced from the waveguide to apply an electric field to the core of the waveguide. The III-nitride-based layer is single-crystalline. The core of the waveguide further includes a buffer layer disposed between the III-nitride-based layer and the substrate. The buffer layer includes a III-nitride-based material. The III-nitride-based material is AlN. The waveguide is configured as a resonator. The waveguide is configured as a ring resonator. The waveguide is configured as a bus waveguide. The waveguide is configured for second harmonic generation. The III-nitride-based layer includes ScAlN. The substrate includes sapphire. The photonic device further includes an optical input supported by the substrate, an optical output supported by the substrate, and the waveguide is disposed between the optical input and the optical output. The guiding layer is supported by, and in contact with, the III-nitride-based layer. The III-nitride-based layer is supported by, and in contact with, the guiding layer. The guiding layer includes silicon nitride. The III-nitride-based layer is single-crystalline. The heterostructure further includes a buffer layer disposed between the III-nitride-based layer and the substrate. Forming the guiding layer is implemented after growing the III-nitride-based layer. Forming the guiding layer is implemented before growing the III-nitride-based layer. Patterning the guiding layer does not pattern the III-nitride-based layer. Patterning the guiding layer also patterns the III-nitride-based layer.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts schematic illustrations of (a) a perspective view of a photonic device having a hybrid ScAlN/Si₃N₄ ring resonator structure in accordance with one example, and (b) a sectional view of the photonic device.

FIG. 2 depicts a scanning electron microscope (SEM) image of an etched Si₃N₄ sidewall of an example hybrid ScAlN/Si₃N₄ ring resonator structure, in which the sidewall exhibits low roughness.

FIG. 3 depicts (a, b) schematic illustrations of microring resonator modulator (MRM) device and a magnified ring resonator having a waveguide with a hybrid or composite core in accordance with one example, as well as (c) a schematic, sectional view of an MRM device having a hybrid waveguide core in accordance with one example.

FIG. 4 depicts graphical plots of (a) a measured transmission spectrum of an example microring resonator device, (b) and a single resonance peak with fitting for the example microring resonator device.

FIG. 5 is a flow diagram of a method of fabricating an MRM device having a waveguide with a hybrid or composite core in accordance with one example.

FIG. 6 is a schematic, sectional view of an MRM device having a waveguide with a hybrid or composite core in accordance with another example.

FIG. 7 is a schematic, sectional view of an MRM device having a waveguide with a hybrid or composite core in accordance with yet another example.

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Devices having a waveguide with a hybrid or composite core are described. As described herein, the hybrid core includes a III-nitride-based layer, such as ScAlN, and a guiding layer adjacent the III-nitride-based layer. The structure (e.g., heterostructure) of the hybrid core harnesses the strong nonlinearity of the III-nitride-based layer via integration with a low-loss platform, such as SiNₓ, for the guiding layer. As described herein, the guiding layer of the hybrid core establishes a lateral extent of the core (e.g., the width or other lateral dimension transverse to the propagation direction). Methods of fabricating the devices are also described.

A wide range of photonic integrated circuits and other photonic devices may be realized. Examples are described herein in which the hybrid core of the disclosed devices is used to realize a high-Q microring resonator.

The III-nitride-based waveguides of the disclosed devices may exhibit wide range of optical transparency from ultraviolet (UV) to mid-infrared (IR) wavelengths. The III-nitride-based platform enables active and passive PIC components with high power handling properties and second- and third-order nonlinear optical properties. These features allow a variety of linear and nonlinear PIC devices operating over a broad range of wavelengths to be realized. For instance, various PIC devices may be realized, including, for instance, high-Q resonators, electro-optic (EO) modulators, on-chip frequency comb, and devices exhibiting generation of second or third harmonics.

In some cases, the III-nitride-based layer is composed of, or otherwise includes, a III-nitride alloy, such as ScAlN. The doping of AlN with scandium (Sc) can enhance its piezoelectricity by a factor of 5 and the χ⁽²⁾ by a factor of 12, which exceeds LiNbO₃ when the Sc composition is >36%. ScAlN has also exhibited robust ferroelectricity. High quality, single crystalline ferroelectric ScAlN layers may be grown by plasma-assisted MBE, in which the Sc content may be tuned by the Sc/Al beam flux ratio during the growth.

Although described in connection with heterostructures having one or more structures or layers composed of, or otherwise including, ScAlN, the composition and/or other characteristics of the heterostructures of the disclosed devices may vary. Other III-nitride alloys or III-nitride-based materials may be used in the waveguide core. The composition of the ferroelectric component of the waveguide cores of the disclosed devices may thus vary from the examples described herein. The disclosed devices are therefore not limited to layers composed of III-nitride alloys including scandium. For instance, the III-nitride-based ferroelectric layers may include additional or alternative group IIIB elements, such as yttrium (Y) and lanthanum (La).

Although described in connection with waveguide cores including a guiding layer composed of, or otherwise including, SiNₓ, the composition and/or other characteristics of the guiding layer of the waveguide core of the disclosed devices may vary. Alternative or additional low-loss materials may be used, including, for instance, lithium niobate (LiNbO₃) and silicon (Si).

Further details regarding non-ferroelectric components, structures, and/or other aspects of the disclosed photonic devices may be found in Sun et al., “Ultrahigh Q microring resonators using a single crystal aluminum-nitride-on-sapphire platform,” Optics Letters, Vol. 44, No. 23, pp. 5679-5681 (2019), and Shin et al., “Demonstration of green and UV wavelength high Q aluminum nitride on sapphire microring resonators integrated with microheaters,” Appl. Phys. Lett. 118, 211103 (2021), the entire disclosures of which are hereby incorporated by reference.

Although described in connection with microring resonator (MRR) and microring resonator modulator (MRM) devices, the disclosed heterostructures and devices may be incorporated into to a wide variety of photonic devices. For instance, the heterostructures may be configured as, or otherwise include, non-ring shaped resonator structures, such as photonic crystal structures. The disclosed heterostructures and devices may also be configured for photonic functions other than modulation.

Although described in connection with examples having a buffer layer composed of AlN, the buffer layer of the disclosed devices may include alternative or additional III-nitride semiconductor buffer, template, base, or other layers. For instance, the buffer layer may be composed of, or otherwise include, GaN. Additional or alternative types of materials may also be used in the heterostructures, including, for instance, other semiconductor materials. For instance, other nitride semiconductors, such as II-IV-Nitrides (e.g., ZnGeN₂, ZnSiN₂, ZnMgN₂, and related alloys), may be used as a buffer or other layer. In such cases, the composition of the ferroelectric layer may vary accordingly.

Although described in connection with examples having a sapphire substrate, alternative or additional substrate materials may be used. For instance, the substrates of the disclosed devices may be composed of, or otherwise include, Ga₂O₃, SiOₓ, Si, SiNₓ, Al, and Mo.

Further details on the epitaxial growth conditions, procedures, and related parameters that may be used to form the III-nitride-based ferroelectric layer described herein are set forth in WO 2023/022768 (“Epitaxial Nitride Ferroelectronics”), International Application No. PCT/US23/13727 (“Epitaxial Nitride Ferroelectronic Devices” filed Feb. 23, 2023), P. Wang, et al., “Fully epitaxial ferroelectric ScAlN grown by molecular beam epitaxy,” Applied Physics Letters, vol. 118, p. 223504 (2021), D. Wang et al., “An Epitaxial Ferroelectric ScAlN/GaN Heterostructure Memory,” Advanced Electronic Materials, p. 2200005 (2022), D. Wang, et al., “Fully epitaxial ferroelectric ScGaN grown on GaN by molecular beam epitaxy,” Appl Phys Lett 119 (11), 111902 (2021), D. Wang et al., “Impact of dislocation density on the ferroelectric properties of ScAlN grown by molecular beam epitaxy,” Appl Phys Lett 121 (4), 042108 (2022), and P. Wang et al., “Quaternary alloy ScAlGaN: A promising strategy to improve the quality of ScAlN,” Appl Phys Lett 120 (1), 012104 (2022), the entire disclosures of which are hereby incorporated by reference.

Although the disclosed methods are described in connection with MBE growth procedures, additional or alternative non-sputtered epitaxial growth procedures may be used. For instance, metal-organic chemical vapor deposition (MOCVD), hydride vapor phase epitaxy (HVPE), atomic layer deposition (ALD), and atomic layer epitaxy (ALE) growth procedures may be used. Still other procedures may be used, including, for instance, pulsed laser deposition procedures.

Examples are described below in which the integration of Si₃N₄ and ScAlN realizes benefits from both the low propagation loss offered by the Si₃N₄ and the strong optical nonlinearity from the ScAlN. These benefits, in turn, are useful in providing a high-performance integrated photonics platform that does not suffer from the drawbacks of relying on ScAlN alone. One drawback is the increasing loss induced by higher Sc composition in the materials. Another drawback relates to the microfabrication process, in which a by-product formed during a ScAlN dry etching stage, ScCl₃, exhibits a relatively lower vapor volatility compared with other components, such as AlCl₃. This will, in turn, lower the etch rate, deteriorate the selectivity between the nitride film and the mask, and potentially lead to redeposition, which may adversely affect the sidewall roughness and incur more scattering loss in the device.

To mitigate or remove these challenges, a III-nitride-based film (e.g., a ScAlN layer) of the waveguide core of the disclosed devices is grown via plasma assisted molecular beam epitaxy (PA-MBE), which epitaxially deposits single-crystalline ScAlN on, for instance, a sapphire substrate. The nature of the epitaxial growth provides a layer of high quality material, e.g., with lower defect density and potentially lower absorption that would otherwise cause propagation losses.

In some cases, and as described herein, the ScAlN or other III-nitride-based layer remains un-etched. The optical mode guiding in the waveguide core is instead achieved or otherwise established by a guiding layer of the waveguide core of the disclosed devices. In the examples described below, the guiding layer is provided by a patterned Si₃N₄ layer. The incorporation of, and reliance on, the guiding layer avoids efforts directed to, for instance, the optimization of ScAlN etching conditions. Scattering losses are also further reduced.

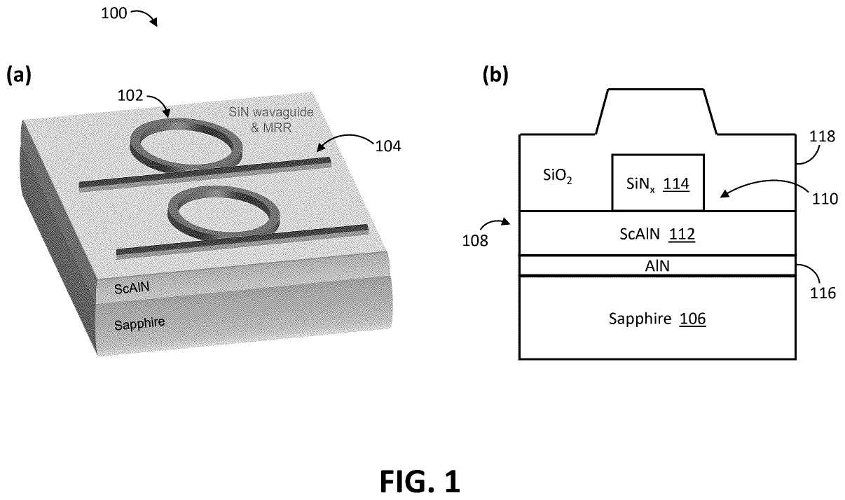

An example device 100 having the above-described composite structure as a hybrid or composite waveguide core is illustrated in FIG. 1, part (a). A sectional view of the example device 100 is shown in FIG. 1, part (b). In this example, the structures of the device 100 are patterned to form a ring resonator 102 spaced from a bus waveguide 104. In some cases, the bus waveguide 104 also includes the above-described composite structure or hybrid waveguide core.

As shown in FIG. 1, part (b), the example device 100 includes a substrate 106 and a heterostructure 108 supported by the substrate 106. The heterostructure 108 is configured as, or otherwise includes, a waveguide. The heterostructure or waveguide 108 has a core 110 that, in turn, includes a III-nitride-based layer 112 and a guiding layer 114 adjacent the III-nitride-based layer 112. In the example of FIG. 1, the guiding layer 114 is supported by the III-nitride-based layer 112. As described herein, the III-nitride-based layer 112 is ferroelectric, and the guiding layer 114 has a layout that establishes a lateral extent of the core 110. The ferroelectric III-nitride-based layer 112 may be single-crystalline as described herein. As shown in FIG. 1, the III-nitride-based layer 112 may be composed of, or otherwise include ScAlN, and the guiding layer 114 may be composed of, or otherwise include, silicon nitride (SiNₓ). In this example, the core 110 further includes a buffer layer 116 disposed between the III-nitride-based layer 112 and the substrate 106. As shown in FIG. 1, the buffer layer 116 may be composed of, or otherwise include, AlN. In one example, a 250 nm Sc_{0.2}Al_{0.8}N layer 112 was initially grown on a sapphire substrate 106 with a thin (50 nm) buffer layer 116 of AlN to compensate the large lattice mismatch between the ScAlN layer 112 and the sapphire substrate 106. A 450 nm Si₃N₄ layer was then deposited via low-pressure chemical vapor deposition (LPCVD) as the guiding layer 114.

To pattern the guiding layer 114, a layer of amorphous Si (a-Si) was deposited via plasma-enhanced chemical vapor deposition (PECVD). The amorphous layer was used as a hard mask for etching the Si₃N₄ layer. E-beam lithography with negative tone resist was then applied to define the waveguide and microring resonator devices in a compact fashion, while maintaining a smooth profile for lower sidewall roughness.

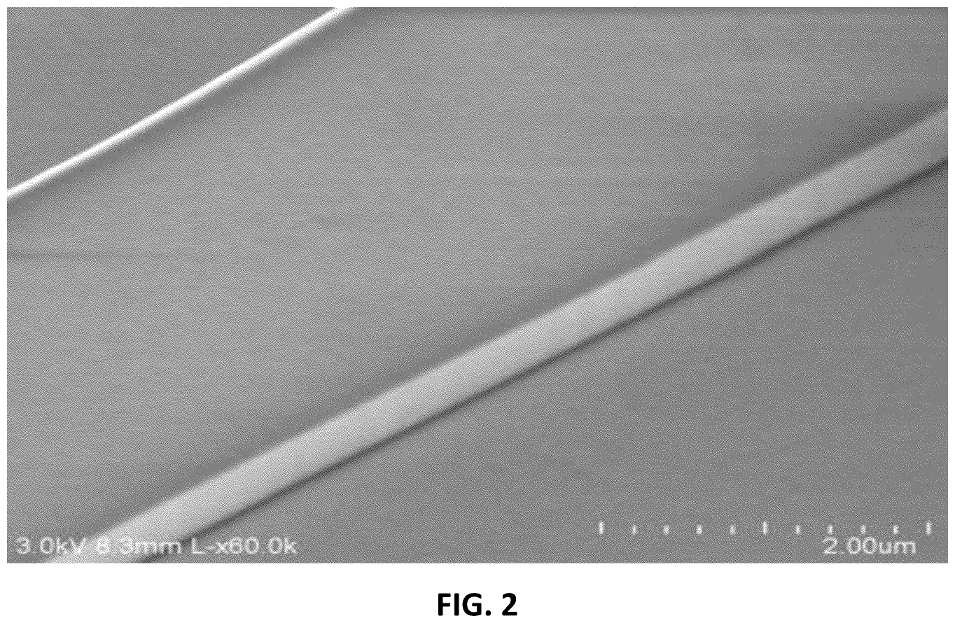

After the device patterning by developing and etching, a very smooth sidewall was achieved, as shown in FIG. 2. The smooth sidewall supports high Q-factor performance by virtue of the well-developed process for Si₃N₄ etching. The a-Si mask was then completely removed in XeF₂.

As shown in FIG. 1, part (b), the waveguide core 110 was then capped with a SiO₂ cladding layer 118 via PECVD. Alternative or additional materials may be used for the cladding layer 118.

Because the heterostructure was grown on sapphire substrate, which is a relatively hard material, waveguide coupling facets were formed by abrasive polishing to implement edge coupling. Alternative or additional procedures may be used to form or provide optical input and output ports or other structures.

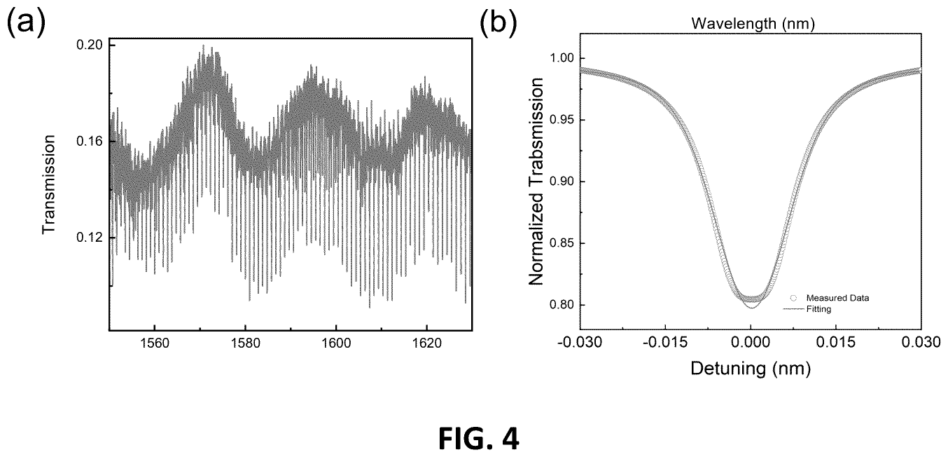

To test the example device, the polarization of a light source was calibrated to be in TE mode before coupling of fibers to the input and output ends. The example device had a 200 μm radius and 650 nm gap, and exhibited the transmission spectrum shown in FIG. 4, part (a). By fitting the resonance peaks, the intrinsic Q-factors were found to be above 1×10⁵, with a maximum value up to 1.4×10⁵, as plotted in FIG. 4, part (b).

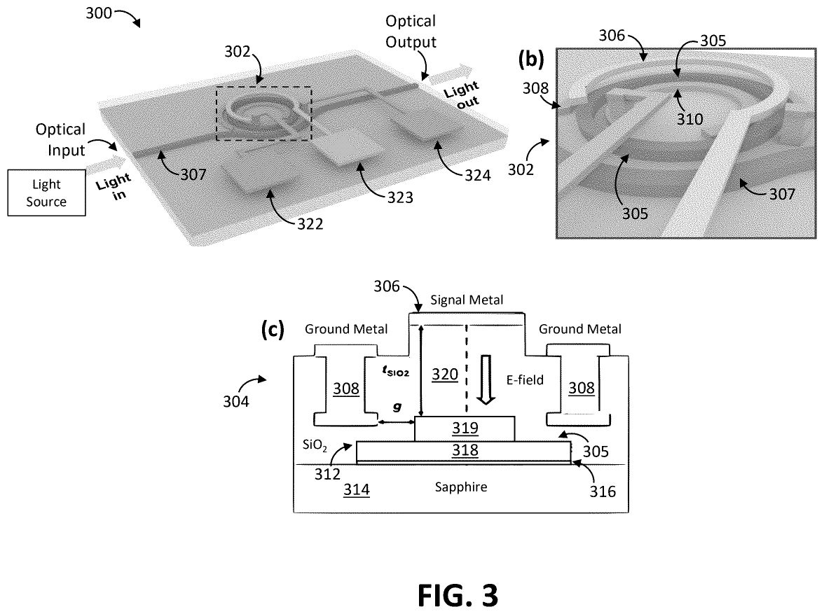

FIG. 3 depicts a photonic device 300 having a ferroelectric ScAlN layer in accordance with one example. The photonic device 300 may be configured as, or include, a microring modulator device (MRM). The photonic device 300 may include a microring resonator as described above in connection with FIG. 1 and/or a different microring resonator.

FIG. 3, parts (a) and (b), schematically show an MRM device 300 having a ring resonator 302 in accordance with one example. The ring resonator 302 includes a waveguide with a core having a hybrid or composite structure as described herein. FIG. 3, part (c), shows the cross-sections of an example ring resonator 304. The ring resonator 302 of the device 300 may be configured in accordance with the example resonator 304 shown in FIG. 3, part (c). Features in common between the examples are accordingly labeled with common reference numerals.

In the examples shown in FIG. 3, ground metal electrodes or structures 308, 310 are disposed on or along the lateral sides of a core 305 (or waveguide core, or waveguide) of the ring resonator 304, and a signal metal electrode or structure 306 is placed on top of the ring resonator 304 above the core 305, which may be wider than a bus waveguide 307 of the MRM device 300 to provide a uniform electric field in the waveguide.

As described herein, each waveguide core 305 includes a heterostructure 312 supported by a substrate 314 (e.g., sapphire substrate). Each heterostructure 312, in turn, includes a base (or buffer) layer 316, a ferroelectric III-nitride-based layer 318 supported by the base layer 316, and a guiding layer 319 adjacent the ferroelectric III-nitride-based layer 318. In this example, the ferroelectric III-nitride-based layer 318 is composed of, or otherwise includes, ScAlN. The base layer 316 may be composed of, or otherwise include, aluminum nitride (AlN) and/or another III-nitride-based material (e.g., GaN). The ferroelectric III-nitride-based layer 318 may be single-crystalline as described herein.

In the example of FIG. 3, the guiding layer 319 is supported by the ferroelectric III-nitride-based layer 318. In other cases, the ferroelectric III-nitride-based layer 318 is supported by the guiding layer 319. As described herein, the guiding layer 319 is composed of, or otherwise includes, a low-loss material, such as SiNₓ. Alternative or additional materials may be used, including, for instance, lithium niobate and silicon.

In some cases, the heterostructure 312 of each waveguide core 305 may further include one or more additional layers. For instance, a (further) buffer layer may be disposed between the base layer 316 and the ferroelectric layer 318. In some cases, the further buffer layer has the same composition as the base layer (e.g., AlN). In other cases, the further buffer layer has a different composition than the base layer 316. For instance, the base layer 316 may be composed of, or otherwise include, GaN, while the buffer layer may be composed of, or otherwise include, AlN. The use of AlN may be useful to enhance optical confinement.

The positions of the signal structure 306 and the ground metal structures 308, 310 may be optimized for maximizing the applied electric field in the waveguide core 305 and minimizing any optical absorption due to the proximity of these metals to the resonator. For instance, the signal structure 306 may be alternatively or additionally disposed along sidewalls of the ferroelectric III-nitride-based layer 318.

The gap between the ring resonator 302 and the bus waveguide 307, and the width of the bus waveguide 307, may be optimized or otherwise configured for enhanced waveguide-resonator coupling and their phase-matching condition.

The device 300 may further include a cladding layer 320. In the case of FIG. 3, the cladding layer 320 is composed of, or otherwise includes, SiO₂. Additional or alternative materials may be used. For instance, in one example, an Al₂O₃ layer may be disposed between the SiO₂ layer and the ferroelectric layer 318.

The device 300 may include fewer, alternative, or additional structures, elements, or features. For instance, the signal electrode 306 and the ground metal electrodes or structures 308, 310 may include one or more structures spaced from the ring resonator 302. In the example of FIG. 3, the signal electrode 306 and the ground metal electrodes or structures 308, 310 include contact pads 322, 323, 324, respectively. The configuration and other characteristics of the signal electrode 306 and the ground metal electrodes or structures 308, 310 may vary from the example shown.

The manner in which optical signals are coupled to, and received from, the device 300 may vary. As shown in FIG. 3, part (a), the device 300 may include a light source or other optical input and an optical output. In some cases, the optical input and/or the optical output is supported by the substrate 314. Each of the optical input and/or the optical output may include an optical port and/or other device coupled to the bus waveguide 307. The construction, configuration and other characteristics of the optical port(s), and the optical input and the optical output more generally, may vary. For instance, in some cases, the optical input and/or the optical output may be integrated to any desired extent with the bus waveguide 307.

Further details regarding the process of fabricating the portions of the MRM devices outside of the waveguide core can be found in Shin, W. et al., “Demonstration of green and UV wavelength high Q aluminum nitride on sapphire microring resonators integrated with microheaters,” Appl Phys Lett 2021, 118 (21), 211103, the entire disclosure of which is hereby incorporated by reference. In some cases, after defining the microring resonator, buffered HF is used to remove the two layers of the hard mask, SiO₂ and Al₂O₃. An SiO₂ layer may be deposited with plasma-enhanced chemical vapor deposition (PECVD). Alternative or additional layers may be deposited via atomic layer deposition (ALD). Then one or more metal layers (e.g., Ti, Au, and/or Al) may be directly deposited on the lateral sides of the ScAlN ring resonator as the ground metal structures, followed by PECVD SiO₂ deposition of the cladding layer. The signal metal structure (e.g., metal stack) may be sputtered on top of the SiO₂ cladding layer, underneath which the ring resonator is located. After making SiO₂ openings for via contacts, further metal stacks are evaporated as a metal via and the ground-signal-ground (GSG) contact pads. Finally, dicing and polishing to expose the waveguide facets of the optical input and optical output (e.g., optical ports) are performed.

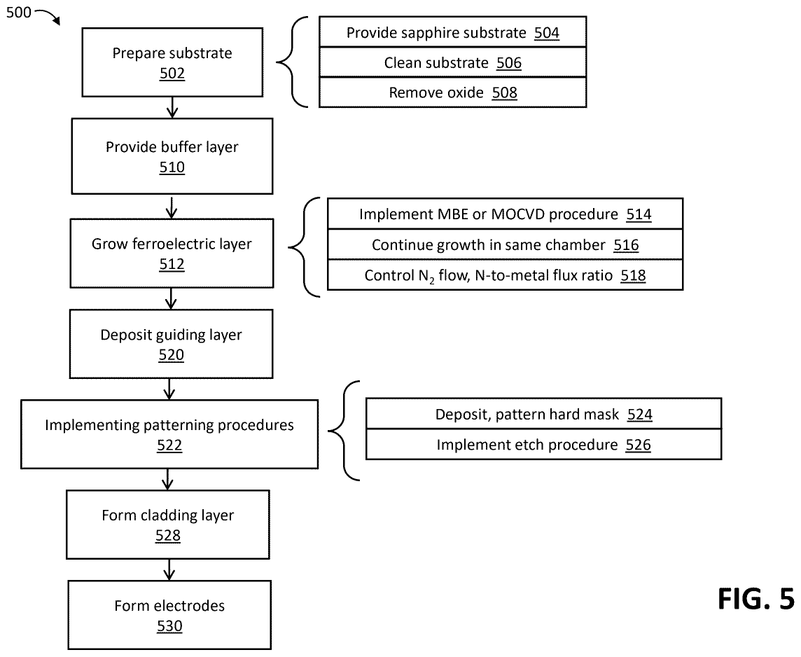

FIG. 5 depicts a method 500 of fabricating a transistor device having a heterostructure with a capped barrier layer in accordance with one example. The method 500 may be used to fabricate the example HEMT devices described herein and/or other transistor devices.

The method 500 may begin with an act 502 in which a substrate is prepared and/or otherwise provided. In some cases, the act 502 includes providing a sapphire substrate in an act 504. Alternative or additional materials may be used, including, for instance, silicon, bulk GaN, bulk AlN, or other semiconductor material. Still other materials may be used, including, for instance, silicon carbide. The substrate may be cleaned in an act 506. In some cases, a native or other oxide layer may be removed from a substrate surface in an act 508. Additional or alternative processing may be implemented in other cases, including, for instance, doping or deposition procedures. The substrate thus may or may not have a uniform composition. The substrate may be a uniform or composite structure.

In an act 510, one or more buffer layers are provided. Each buffer layer is supported by the substrate. In some cases, the layer(s) are provided with the substrate. The act 510 may thus be implemented before (e.g., in preparation for) implementing an epitaxial growth procedure in which a number of epitaxial layers of a heterostructure are formed. In other cases, the buffer layer(s) are formed (e.g., grown or deposited) on the substrate. The layer(s) may or may not be in contact with the substrate. The buffer layer(s) may or may not act as a growth template for one or more layers of the heterostructure.

In some cases, the buffer layer(s) are composed of, or otherwise include, a semiconductor material. For example, a III-nitride layer, such as a semi-insulating GaN layer, may be grown or otherwise formed on the substrate. Other compound or other semiconductor materials may be used, including, for instance, AlGaN and non-III-nitride materials, as described above. The heterostructure may thus be formed on the semiconductor layer.

In some cases, the act 510 may include growing the buffer layer in an epitaxial growth chamber in which the epitaxial growth procedure(s) for a heterostructure of the device is/are implemented. As a result, the substrate may remain within, e.g., is not removed from, the epitaxial growth chamber between forming the buffer layer and implementing the epitaxial growth procedure(s) for growing the heterostructure.

In an act 512, a ferroelectric III-nitride-based layer of the heterostructure of the waveguide core is grown. As described herein, the ferroelectric layer may be composed of, or otherwise includes, an alloy of a III-nitride material. For instance, the III-nitride material may be AlN. Additional or alternative III-nitride materials may be used, including, for instance, gallium nitride (GaN), indium nitride (InN), and their alloys. As also described herein, an epitaxial growth procedure is implemented and configured to incorporate scandium and/or another group IIIB element into the alloy of the III-nitride material. The alloy may thus be ScₓAl₁₋ₓN, for example. Additional or alternative III-nitride alloys may be used, as described above. In some cases, the act 520 includes an act 518 in which an MBE procedure is implemented. In other cases, an MOCVD or other non-sputtered epitaxial growth procedure is implemented.

The epitaxial growth procedure used to grow the buffer layer may be continued (e.g., a continuous growth procedure) to grow the III-nitride-based layer. Thus, the substrate may remain in the same growth chamber during the acts 510 and 512. The act 512 may thus constitute a continuation, or part of a sequence, of the growth procedures used to form other layers of the heterostructure. The growth procedures may be implemented in a common, or same, growth chamber without removal therefrom. The act 512 may thus include an act 516 in which epitaxial growth is continued in the same chamber. Sequential layers of the heterostructure may thus be grown without exposure to the ambient. The quality of the interface between the layers may accordingly be improved.

The growth temperature may be at a level such that the III-nitride-based layer has a wurtzite structure that exhibits a breakdown field strength greater than a ferroelectric coercive field strength of the wurtzite structure. The III-nitride-based layer may thus exhibit ferroelectric switching and other behavior.

In some cases, the growth temperature is at a level lower than what would be expected given the III-nitride material. In some examples, the growth temperature level is significantly less than the temperature at which the III-nitride material would typically be grown. For instance, the growth temperature level may be such that attempts to grow a structure composed of the III-nitride material (i.e., without scandium) at the growth temperature level would not be worthwhile. The resulting structure would be of such poor quality (e.g., possess far too many defects) to be useful. Growth of a single crystal of the scandium-including alloy (e.g., a monocrystalline layer of the alloy) at the growth temperature level may nonetheless be achieved. For example, in some cases, a ScₓAl₁₋ₓN alloy may be epitaxially grown at a growth temperature of about 650 degrees Celsius or about 750 degrees Celsius despite that the corresponding (scandium-free) III-nitride material, AlN, is conventionally grown at much higher temperatures, e.g., about 1000 degrees Celsius. Conversely, attempts to grow AlN at about 650 degrees Celsius, about 750 degrees Celsius, or lower than about 650 or 750 degrees Celsius, would result in structures of such poor quality so as to be useless. In contrast, the epitaxially grown ScₓAl₁₋ₓN layer grown at such low or even lower temperatures is unexpectedly monocrystalline and of high quality.

The low growth temperature may be applied in cases in which the nitrogen-to-metal (V/III) flux ratio is slightly or moderately nitrogen-rich. For example, the V/III flux ratio may be in a range between about 1-to-1 to about 2-to-1. In other cases in which the nitrogen-to-metal flux ratio is highly unbalanced, i.e., an extreme N-rich regime, as described herein, the growth temperature may be higher. For instance, the V/III flux ratio may be higher than about 2-to-1. In such highly unbalanced cases, the growth temperature may be at a level and/or otherwise fall in a range that includes temperatures at which the III-nitride material (i.e., without scandium) would typically be grown.

The highly unbalanced, extremely N-rich conditions may be used in connection with formation of the wurtzite structure via sputter deposition. The aforementioned defects presented by past efforts to use sputtering to achieve a ferroelectric layers, such as ScₓAl₁₋ₓN layers are avoided as a result of the use of the highly unbalanced, extremely N-rich conditions.

In slightly to moderately unbalanced, N-rich cases, growth of the ScₓAl₁₋ₓN layer at the conventional AlN growth temperature (and other temperatures above the upper bound) unexpectedly results in the formation of dislocations and/or other leakage paths in the ScₓAl₁₋ₓN layer. With the leakage paths, the ScₓAl₁₋ₓN layer has a breakdown field strength level too low (e.g., below the ferroelectric coercive field strength level). The layer accordingly does not exhibit ferroelectric behavior.

In some cases (e.g., slightly to moderately unbalanced, N-rich cases), the growth temperature may be about 650 degrees Celsius or less or about 750 degrees Celsius or less. The growth temperature may correspond with the temperature measured at a thermocouple in the growth chamber. The growth temperature at the epitaxial surface may be slightly different. The growth temperature is accordingly approximated via the temperature measurement at the thermocouple.

The upper bound of the growth temperature range in slightly to moderately unbalanced, N-rich cases may vary in accordance with the alloy and/or the epitaxial growth technique. For instance, in other slightly to moderately unbalanced, N-rich cases, the upper bound on the growth temperature may be higher, such as about 680 degrees Celsius, or about 690 degrees Celsius. In still other slightly to moderately unbalanced, N-rich cases, the upper bound may be lower, including, for instance, about 600 degrees Celsius or about 620 degrees Celsius.

The growth temperature may vary in cases in which other process parameters differ from those described above. For instance, a higher growth temperature may be used in cases in which the nitrogen-metal flux ratio is highly or extremely unbalanced as described below. The nitrogen-to-metal flux ratio may be set in an act 518 in which the nitrogen flow is controlled. In some cases, the unbalanced flux ratio may be set to a highly or extremely nitrogen (N)-rich condition, such as a N-to-metal flux ratio of 2-to-1 or higher. In such cases, the growth temperature may fall in a range corresponding with those temperatures to grow other III-nitride layer(s) of the device, e.g., in the act 510. For example, growth temperatures about 1000 degrees Celsius may be used. In other highly or extremely N-rich growth condition examples, lower growth temperatures, e.g., those falling in a range from about 600 degrees Celsius to about 1000 degrees Celsius as in the examples described above, may be used.

Control of the flux ratio between metal and nitrogen sources may be useful for improving the material quality of nitride semiconductors, including, for instance, ScₓAl₁₋ₓN. In conventional III-nitrides, slightly metal-rich growth conditions are often used to improve the surface morphology, interface controllability, and crystal quality during the MBE growth processes. Based on the phase diagram of Sc—Al—N, N-rich growth conditions, however, are more favorable for the growth of ScAlN to avoid Sc—Al intermetallic and Sc₃AlN perovskite phase formation. Whether the film is grown in N-poor or N-rich conditions may result in different formation energy levels for defects, such as cation vacancies (V_{cation}) and nitrogen vacancies (V_{N}), which may further affect the electrical properties, including, for instance, leakage current and breakdown strength.

Such highly N-rich growth conditions may be employed in connection with MBE, MOCVD and other epitaxial growth processes. The highly N-rich growth conditions may also be utilized in connection with films formed via sputter deposition.

At each level within the above-described ranges of suitable growth temperatures, the resulting wurtzite structure is monocrystalline. The resulting wurtzite structure is monocrystalline to a degree not realizable via, for instance, sputtering-based procedures for forming ScₓAl₁₋ₓN layers. Such procedures are only capable of producing structures with x-ray diffraction rocking curve line widths on the order of a few degrees at best. In contrast, the structures grown by the disclosed methods exhibit x-ray diffraction rocking curve line widths on the order of a few hundred arc-seconds or less, well over an order of magnitude less. In this manner, leakage current paths are minimized or otherwise sufficiently reduced so that the resulting wurtzite structure has a suitably high breakdown field strength level, e.g., sufficiently greater than the ferroelectric coercive field strength.

The above-noted differences in crystal quality evidenced via x-ray diffraction rocking curve line widths may also be used to distinguish between monocrystalline and polycrystalline structures. As used herein, the term “polycrystalline” refers to structures having x-ray diffraction rocking curve line widths on the order of a few degrees or higher. As used herein, the term “monocrystalline” refers to structures having x-ray diffraction rocking curve line widths at least one order of magnitude lower than the order of a few degrees.

Comparing the wurtzite structures of the layers grown by MBE or other non-sputtered techniques (e.g., MOCVD or HVPE) with sputtering deposition techniques, the microstructure of the former techniques is more uniform with highly ordered stacking sequence of atoms. In sputter deposited layers, domains with cubic phase or domains with in-plane mis-orientation are readily observed. The existence of these mis-aligned domains suppresses the complete switching of polarization, and further results in the fast loss of polarization during fatigue testing. Regarding phase purity, the highly crystallographic orientation of layers grown by MBE or other non-sputtered techniques exhibits more repeatable ferroelectric switching, which is useful in a number of device applications.

The III-nitride-based layer may then be annealed. The annealing may be implemented at a temperature greater than the growth temperature. In some cases, the annealing temperature falls in a range from about 700 Celsius to about 1500 degrees Celsius. Examples of films prepared with such annealing exhibited stable polarization switching with further reduced leakage current relative to non-annealed films. Film or device uniformity was also improved via the annealing, thereby further improving the polarization switching behavior of the ferroelectric Sc-III-N alloys. The underlying mechanism for the improved performance and uniformity with annealing is attributed to the reduced threading dislocation density and defect density, which usually act as electric leakage paths. Such usefulness of the post-growth annealing is realized despite past concerns that high processing temperatures can lead to a loss of ferroelectricity.

Such post-growth high-temperature annealing of ScₓAl₁₋ₓN may be performed in-situ in the same growth chamber (e.g., the same MBE chamber) in an act 526. The annealing process may be implemented under high vacuum in an act 528 (e.g., in-situ in the growth chamber). In other cases, the annealing may be implemented either with nitrogen plasma radiation or under nitrogen gas flow in an act 530.

The above-described annealing procedure may be implemented in connection with films grown under any of the above-described growth conditions. For instance, the annealing procedure may be implemented after growth under slightly to moderately N-rich conditions at a growth temperature at or below about 650 degrees Celsius, or at or below about 750 degrees Celsius. The annealing procedure may also be implemented after growth under other unbalanced flux ratios (e.g., N-rich or extreme N-rich conditions) at growth temperatures above about 650 degrees Celsius or above about 750 degrees Celsius.

The method 500 further includes depositing a guiding layer of the waveguide core in an act 520. The guiding layer may be deposited via implementation of a low-pressure chemical vapor deposition (LPCVD) and/or another procedure. A layout of the guiding layer is then defined in an act 522 via the implementation of one or more patterning procedures. As described herein, the guiding layer is patterned such that the layout of the guiding layer establishes a lateral extent (e.g., width or other lateral dimension transverse to propagation) of the waveguide core. For instance, a hard mask may be deposited and patterned in an act 524, after which an etch procedure is implemented in an act 526. In some cases, the etch procedure selectively etches only the guiding layer. In other cases, the etch procedure also etches or otherwise patterns the III-nitride-based layer.

A cladding layer may be formed in an act 528. As described herein, the cladding layer may cover or otherwise be disposed adjacent one or more layers of the waveguide core.

The method 500 may include one or more additional acts directed to the formation of other structures or features of the device. For instance, in the example of FIG. 5, one or more electrodes are formed in an act 520.

The order of the acts of the method 500 may vary from the example shown. For instance, forming the guiding layer may or may not be implemented after growing the III-nitride-based layer. In some cases, forming the guiding layer is implemented before growing the III-nitride-based layer.

The method 500 may include additional, fewer or alternative acts. For instance, the method 500 may include one or more acts directed to forming other waveguides or structures of the device, including, for instance, an optical input and/or an optical output.

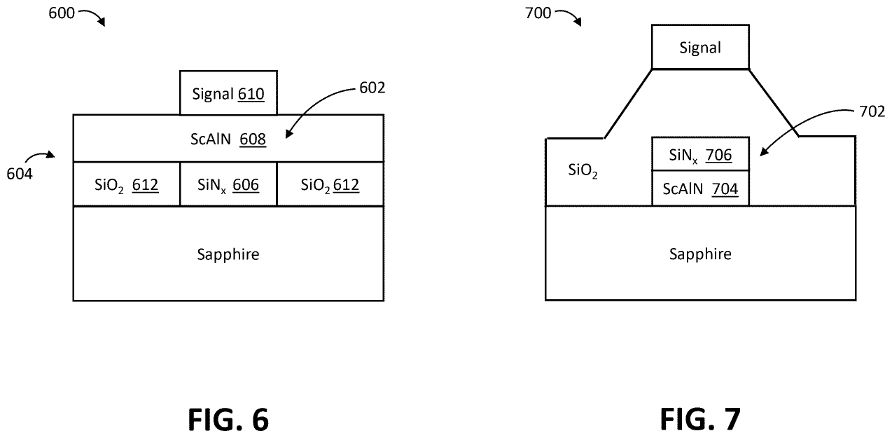

FIG. 6 depicts a photonic device 600 having a hybrid or composite waveguide core 602 in accordance with one example. The hybrid waveguide core 602 may be used in any of the above-described devices, or another device. In this example, the hybrid waveguide core 602 includes a heterostructure 604 that, in turn, includes a guiding layer 606 and a ferroelectric III-nitride-based layer 608 supported by the guiding layer 606. As shown in the example of FIG. 6, with the ferroelectric III-nitride-based layer 608 on top of the guiding layer 606, a signal electrode 610 may disposed directly on (e.g., in contact with) the ferroelectric III-nitride-based layer 608. In other cases, a cladding layer may be disposed between the signal electrode 610 and the ferroelectric III-nitride-based layer 608. In the example of FIG. 6, the photonic device 600 further includes a cladding layer 612 (e.g., silicon dioxide) along sidewalls of the guiding layer 606. Alternative or additional dielectric materials, including air, may be used for the cladding layer 612 along the sidewalls.

FIG. 7 depicts a photonic device 700 having a hybrid or composite waveguide core 702 in accordance with one example. The hybrid waveguide core 702 may be used in any of the above-described devices, or another device. In this example, both components of the hybrid composite waveguide core 702 establish the lateral extent of the core 702. As shown in FIG. 7, both a III-nitride-based layer 704 and a guiding layer 706 have a layout (e.g., a common layout) that establishes the lateral extent of the waveguide core 702. In other cases, the III-nitride-based layer 704 and the guiding layer 706 have different layouts. In those and other cases, both layers 704, 706 may nonetheless establish the lateral extent of the waveguide core 702.

Described herein are examples of photonic devices with a hybrid structure used to attain high-Q performance. Examples of high-Q ScAlN-based resonator devices were realized via integration with a low-loss Si₃N₄ layer. The integration supported large light-matter interaction on the highly nonlinear ScAlN platform, which is useful in a wide variety of devices and applications, such as microring resonators, frequency comb generation, and quantum communications.

As described above, the III-nitride-based structures of the disclosed devices are monocrystalline. The resulting structures (e.g., wurtzite structures) are monocrystalline to a degree not realizable via, for instance, sputtering-based procedures for forming ScₓAl₁₋ₓN layers. Such procedures are only capable of producing structures with x-ray diffraction rocking curve line widths on the order of a few degrees at best. In contrast, the structures of the disclosed devices exhibit x-ray diffraction rocking curve line widths on the order of a few hundred arc-seconds or less, well over an order of magnitude less.

The above-noted differences in crystal quality evidenced via x-ray diffraction rocking curve line widths may also be used to distinguish between monocrystalline and polycrystalline structures. As used herein, the term “polycrystalline” refers to structures having x-ray diffraction rocking curve line widths on the order of a few degrees or higher. As used herein, the terms “monocrystalline” and “single crystalline” (and derivatives thereof) refer to structures having x-ray diffraction rocking curve line widths at least one order of magnitude lower than the order of a few degrees.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A photonic device comprising:
a substrate; and
a waveguide supported by the substrate, the waveguide having a core;
wherein:
the core of the waveguide comprises a III-nitride-based layer and a guiding layer adjacent the III-nitride-based layer;
the III-nitride-based layer is ferroelectric; and
the guiding layer has a layout that establishes a lateral extent of the core.

2. The photonic device of claim 1, wherein the guiding layer is supported by the III-nitride-based layer.

3. The photonic device of claim 1, wherein the III-nitride-based layer is supported by the guiding layer.

4. The photonic device of claim 3, further comprising a signal electrode configured to apply an electric field to the core of the waveguide, the signal electrode being supported by, and in contact with, the III-nitride-based layer.

5. The photonic device of claim 1, wherein the guiding layer comprises silicon nitride.

6. The photonic device of claim 1, wherein the III-nitride-based layer has a layout that establishes the lateral extent of the core.

7. The photonic device of claim 1, further comprising an electrode spaced from the waveguide to apply an electric field to the core of the waveguide.

8. The photonic device of claim 1, wherein the III-nitride-based layer is single-crystalline.

9. The photonic device of claim 1, wherein the core of the waveguide further comprises a buffer layer disposed between the III-nitride-based layer and the substrate.

10. The photonic device of claim 9, wherein the buffer layer comprises a III-nitride-based material.

11. The photonic device of claim 9, wherein the III-nitride-based material is AlN.

12. The photonic device of claim 1, wherein the waveguide is configured as a resonator.

13. The photonic device of claim 1, wherein the waveguide is configured as a ring resonator.

14. The photonic device of claim 1, wherein the waveguide is configured as a bus waveguide.

15. The photonic device of claim 1, wherein the waveguide is configured for second harmonic generation.

16. The photonic device of claim 1, wherein the III-nitride-based layer comprises ScAlN.

17. The photonic device of claim 1, wherein the substrate comprises sapphire.

18. The photonic device of claim 1, further comprising:
an optical input supported by the substrate;
an optical output supported by the substrate; and
the waveguide is disposed between the optical input and the optical output.

19. A photonic device comprising:
a substrate; and
a heterostructure supported by the substrate;
wherein:
the heterostructure comprises a waveguide;
the waveguide comprises a composite core;
the composite core comprises a III-nitride-based layer and a guiding layer adjacent the III-nitride-based layer;
the III-nitride-based layer is ferroelectric; and
the guiding layer has a layout that establishes a width of the composite core.

20. The photonic device of claim 19, wherein the guiding layer is supported by, and in contact with, the III-nitride-based layer.

21. The photonic device of claim 19, wherein the III-nitride-based layer is supported by, and in contact with, the guiding layer.

22. The photonic device of claim 19, wherein the guiding layer comprises silicon nitride.

23. The photonic device of claim 19, wherein the III-nitride-based layer is single-crystalline.

24. The photonic device of claim 19, wherein the heterostructure further comprises a buffer layer disposed between the III-nitride-based layer and the substrate.

25. A microring resonator device comprising:
a substrate;
a bus waveguide supported by the substrate; and
a ring waveguide supported by the substrate and spaced from the bus waveguide;
wherein:
the ring waveguide has a core;
the core of the waveguide comprises a III-nitride-based layer and a guiding layer adjacent the III-nitride-based layer;
the III-nitride-based layer is ferroelectric; and
the guiding layer has a layout that establishes a lateral extent of the core.

26. A method of fabricating a photonic device, the method comprising:
providing a substrate;
growing a III-nitride-based layer of a waveguide core of the photonic device, the III-nitride-based layer being supported by the substrate and ferroelectric;
forming a guiding layer of the waveguide core, the guiding layer being supported by the substrate and adjacent the III-nitride-based layer;
patterning the guiding layer such that the guiding layer has a layout that establishes a lateral extent of the waveguide core; and
forming a cladding layer adjacent the waveguide core.

27. The method of claim 26, wherein forming the guiding layer is implemented after growing the III-nitride-based layer.

28. The method of claim 26, wherein forming the guiding layer is implemented before growing the III-nitride-based layer.

29. The method of claim 26, wherein patterning the guiding layer does not pattern the III-nitride-based layer.

30. The method of claim 26, wherein patterning the guiding layer also patterns the III-nitride-based layer.
